(19) United States
(12) Patent Application Publication
(10) Pub. No.: US 2015/0333334 A1
(43) Pub. Date: Nov. 19, 2015

(54) LITHIUM ION BATTERY USING COPPER NANOWIRE FABRIC-BASED CURRENT COLLECTOR

(71) Applicant: National Tsing Hua University, Hsinchu (TW)

(72) Inventors: Hsing-Yu Tuan, Hsinchu (TW); Wei-Chung CHANG, Hsinchu (TW)

(21) Appl. No.: 14/466,517

(22) Filed: Aug. 22, 2014

(30) Foreign Application Priority Data
May 15, 2014 (TW) 103117107

(51) Int. Cl. H01M 4/66; H01M 10/0564; H01M 4/583; H01M 4/80; H01M 4/48

(52) U.S. Cl. CPC H01M 4/661; H01M 4/80; H01M 4/483; H01M 4/583; H01M 10/0564; H01M 10/0525

(57) ABSTRACT

A lithium ion battery using a copper nanowire fabric-based current collector comprises an anode, a cathode and a separation unit. The anode has a first current collector and an active material attached to the first current collector. The first current collector includes a copper nanowire fabric. The copper nanowire fabric is in form of a plate, and the active material is attached to the first current collector. The cathode has a second current collector and a lithium compound attached to the second current collector and releasing or absorbing lithium ions. The separation unit is arranged between the anode and the cathode and includes an electrolyte allowing lithium ions to move between the anode and the cathode. The anode has much less weight and further higher energy density than the conventional anode using copper foil as the first current collector.

### FIELD OF THE INVENTION

The present invention relates to a battery, particularly to a lithium ion battery using a copper nanowire fabric-based current collector.

### BACKGROUND OF THE INVENTION

In 1991, the Sony Corporation proposed the first lithium ion battery, which brought electronic products a revolutionary impact. Thereby, many portable electronic products can be miniaturized and lightweighted. A lithium ion battery comprises a positive electrode, a negative electrode, a separating membrane, and an electrolyte. The positive electrode is normally made of a lithium compound and uses aluminum foil as the current collection plate. The negative electrode uses copper foil as the current collection plate, and graphite is the primary active material of the negative electrode. Nowadays, there are still many researches devoted to improving the materials of the positive and negative electrodes and the electrolytes of lithium ion batteries so that the capacitance and safety of lithium ion batteries can be promoted persistently. In addition to applying to portable electronic products, lithium ion batteries are expected to widely apply to electric vehicles in future.

For example, a Europe patent publication No. 2654111 disclosed an electrolytic copper foil of a secondary lithium ion battery. The electrolytic copper foil has 0.2% proof stress of over 250 N/mm² and an elongation of over 2.5% after it is heat-treated at a temperature of 200-400° C. An active material, a roughening treatment or an anti-corrosive treatment is applied to the surface of the electrolytic copper foil. While the electrolytic copper foil is used as the current collector of the negative electrode of a secondary lithium ion battery, repeated charge-discharge cycles would not decrease the capacitance retention rate of the secondary lithium ion battery. Thus, the secondary lithium ion battery has a longer service life. Further, the current collector of the negative electrode would not deform.

However, the lithium ion battery using copper foil as the current collector of the negative electrode still has room to improve in its weight.

### SUMMARY OF THE INVENTION

The primary objective of the present invention is to solve the weight problem, which is likely to occur in the conventional lithium ion battery using copper foil as the current collector of the negative electrode.

To achieve the abovementioned objective, the present invention proposes a lithium ion battery using a copper nanowire fabric-based current collector, which comprises an anode, a cathode and a separation unit. The anode has a first current collector and an active material attached to the first current collector. The cathode has a second current collector and a lithium compound attached to the second current collector and to release or to absorb lithium ions. The separation unit is arranged between the anode and the cathode and includes an electrolyte allowing lithium ions to move between the anode and the cathode.

In one embodiment, the first current collector includes a copper nanowire fabric.

The first current collector using the copper nanowire fabric of the present invention has superior energy density and is 75% lighter than the conventional copper foil-based current collector of the negative electrode.

### BRIEF DESCRIPTION OF THE DRAWINGS

FIG. 1 schematically shows the structure of a lithium ion battery using a copper nanowire fabric-based current collector according to a first embodiment of the present invention;

FIGS. 2A-2C schematically show the process of fabricating a copper nanowire fabric according to the first embodiment of the present invention;

FIG. 3 shows the Tafel curves of a copper nanowire fabric fabricated according to the first embodiment and a copper foil;

FIG. 4 schematically shows the structure of a lithium ion battery using a copper nanowire fabric-based current collector according to a second embodiment of the present invention;

FIGS. 5A-5D schematically show the process of fabricating a germanium/copper nanowire fabric according to the second embodiment of the present invention; and

FIG. 6 shows the results of capacity cycle tests of the lithium ion batteries using nanowire fabrics fabricated in different processes and having different structures.

### DETAILED DESCRIPTION OF THE PREFERRED EMBODIMENTS

The technical contents of the present invention are described in detail in cooperation with the drawings below.

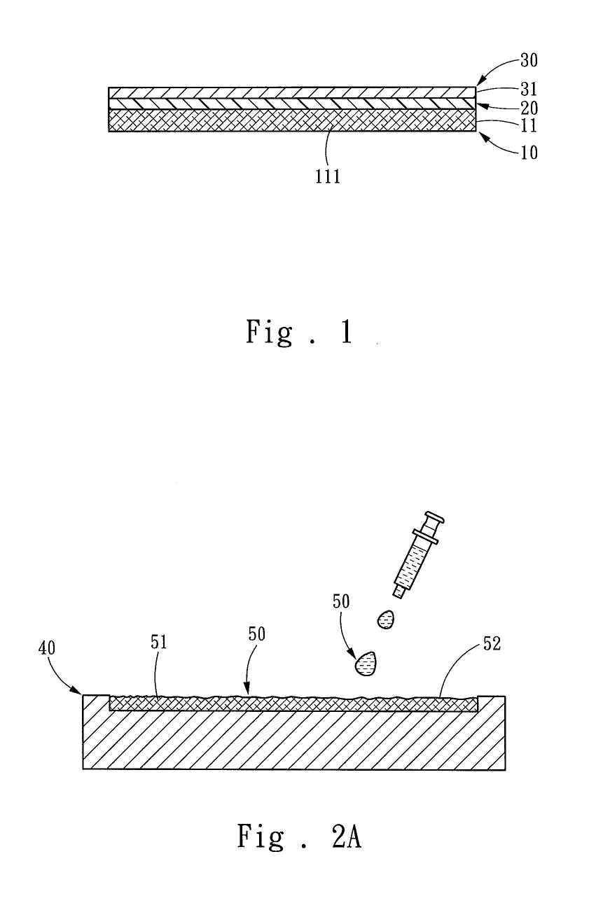

Refer to FIG. 1 schematically showing the structure of a lithium ion battery using a copper nanowire fabric-based current collector according to a first embodiment of the present invention. The lithium ion battery using a copper nanowire fabric-based current collector of the present invention comprises an anode 10, a cathode 30 and a separation unit 20. The anode 10 includes a first charge collector 11 and an active material. The first charge collector 11 includes a copper nanowire fabric 111. The copper nanowire fabric 111 is in form of a plate, and the active material is attached to the first current collector 11. The active material can be made of graphite, silicon, copper phosphide, or germanium, and can be formed in form of particles, powder, nanowires, or a combination thereof. The cathode 30 is arranged opposite to the anode 10 and includes a second current collector 31 and a lithium compound. In one embodiment, the second current collector 31 is made of aluminum in form of a plate, such as aluminum foil. The lithium compound is attached to the second current collector 31, releasing or absorbing lithium ions. The lithium compound is selected from a group consisting of lithium cobalt oxide, lithium manganese oxide, lithium iron phosphate, and lithium nickel cobalt manganese oxide. The separation unit 20 is arranged between the anode 10 and the cathode 30, preventing from the contact and short-circuit of the anode 10 and the cathode 30. The separation unit 20 includes an electrolyte electrically connected with the anode 10 and the cathode 30. The separation unit 20 has a plurality of pores absorbing the electrolyte. The electrolyte allows lithium ions to move between the anode 10 and the cathode 30. The electrolyte has a solute and a solvent. In one embodiment, the solute is Lithium hexafluorophosphate (LiPF6); the solvent is selected from a group consisting of Diethyl carbonate (DEC), Fluoroethylene carbonate (FEC), Ethylene carbonate (EC) and Dimethyl carbonate (DMC).

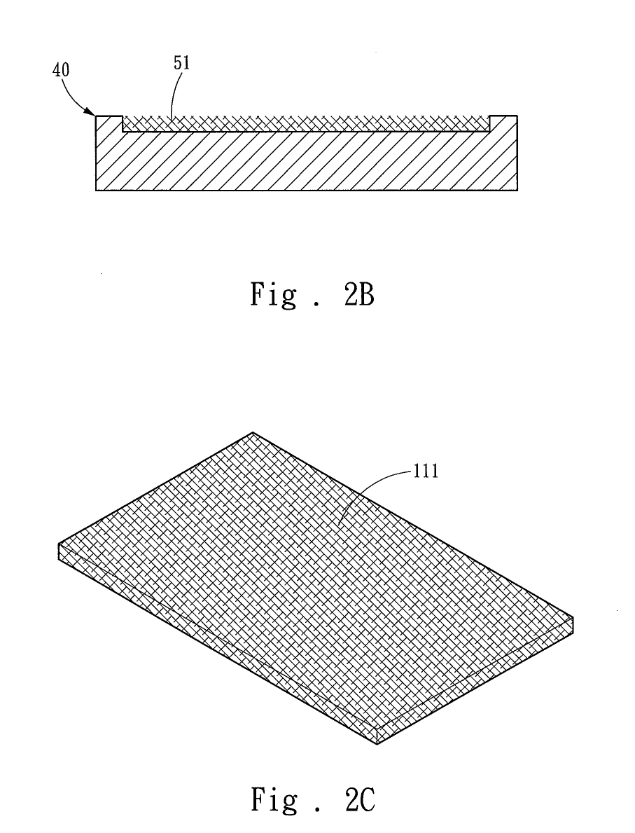

Refer to FIGS. 2A-2C schematically showing the process of fabricating a copper nanowire fabric according to the first embodiment of the present invention. In FIG. 2A, place a copper nanowire solution 50 in a Teflon mold 40. The copper nanowire solution 50 includes a first organic solvent 52 and a plurality of copper nanowires 51 dissolved in the first organic solvent 52. In one embodiment, the first organic solvent 52 is selected from a group consisting of toluene, benzene, hexane, and chloroform. In FIG. 2B, let the first organic solvent 52 vaporize and the copper nanowires 51 remain in the Teflon mold 40. Next, bake the Teflon mold 40 in a vacuum oven to eliminate the residual first organic solvent 52. Then, open the Teflon mold 40 and scrape off the copper nanowires 51. Thus, obtain the copper nanowire fabric 111 where the copper nanowires 51 are interwoven, as shown in FIG. 2C.

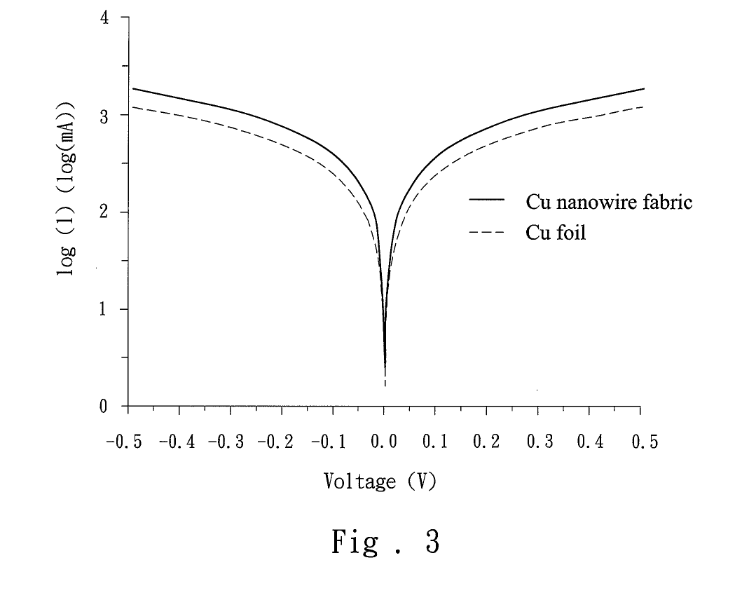

Refer to FIG. 3 for the Tafel curves of a copper nanowire fabric fabricated according to the first embodiment and a copper foil. In this embodiment, the copper nanowire fabric 111 is fabricated to have a size of 2cm×2 cm. However, the present invention does not limit that the copper nanowire fabric 111 must be fabricated to have the abovementioned size. The copper foil is also cut to have the same size. The electric measurements are undertaken to obtain the Tafel curves shown in FIG. 3. It is learned from FIG. 3 that the copper nanowire fabric 111 has electric conductivity slightly higher than that of the copper foil. Therefore, the copper nanowire fabric 111 not only has higher electric conductivity than the copper foil but also is more lightweight than the copper foil.

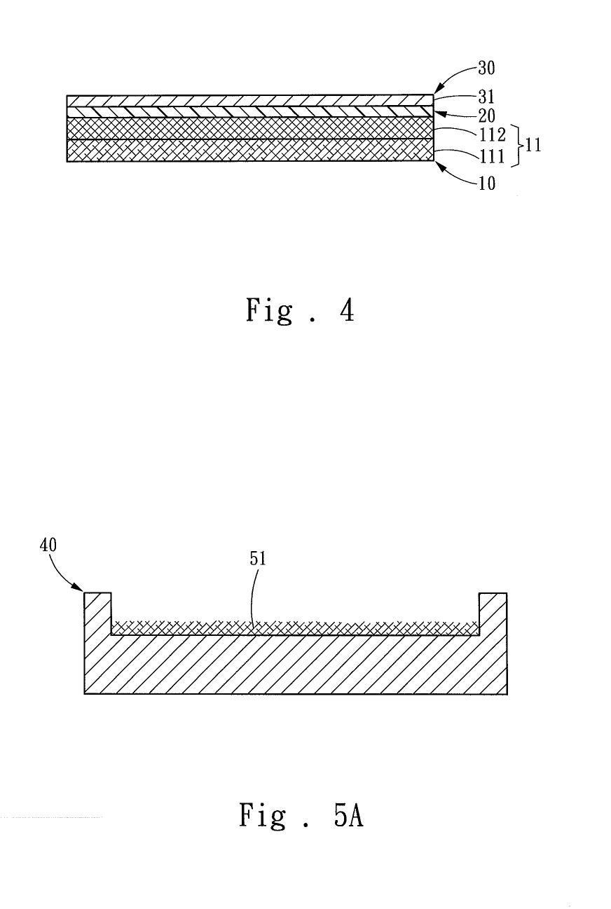

Refer to FIG. 4 schematically showing the structure of a lithium ion battery using a copper nanowire fabric-based current collector according to a second embodiment of the present invention. The second embodiment is characterized in that the anode 10 adopts a germanium nanowire fabric 112 as the active material. The germanium nanowire fabric 112 is attached to the first current collector 11, applied onto the copper nanowire fabric 111 and arranged between the copper nanowire fabric 111 and the separation unit 20.

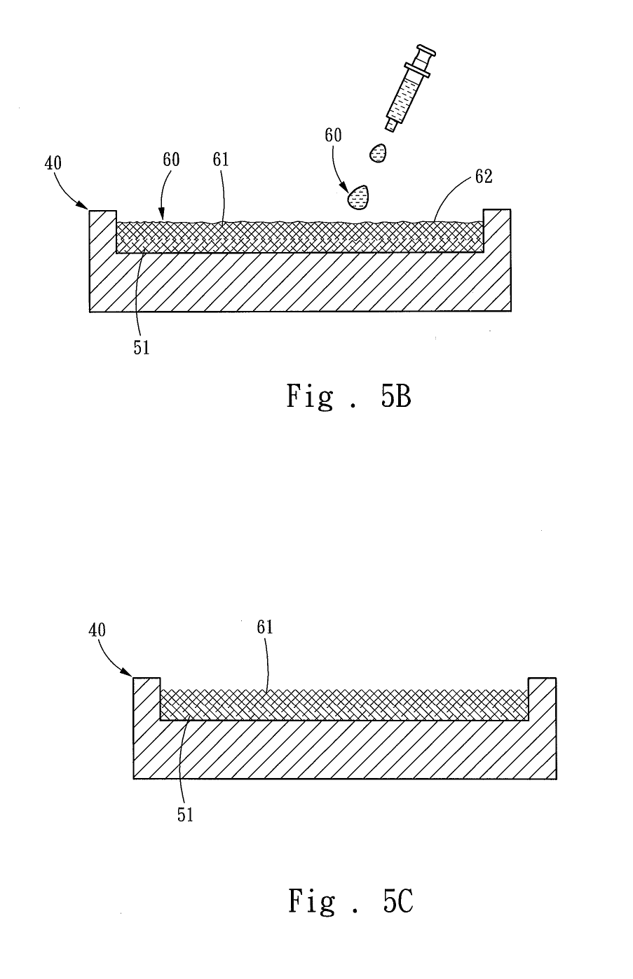

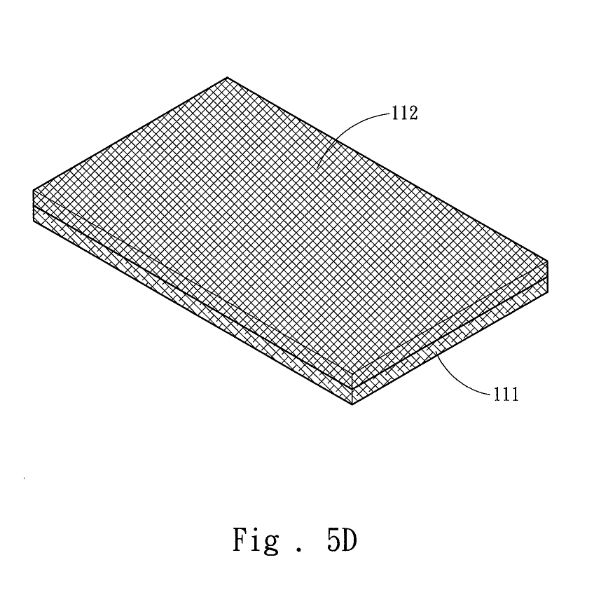

Refer to FIGS. 5A-5D schematically showing the process of fabricating a germanium/copper nanowire fabric according to the second embodiment of the present invention. In FIG. 5A, place a copper nanowire solution 50 in a Teflon mold 40. The copper nanowire solution 50 includes a first organic solvent 52 and a plurality of copper nanowires 51 dissolved in the first organic solvent 52. Let the first organic solvent 52 vaporize and the copper nanowires 51 remain in the Teflon mold 40. In FIG. 5B, drip a germanium nanowire solution 60 into the Teflon mold 40. The germanium nanowire solution 60 includes a second organic solvent 62 and a plurality of germanium nanowires 61 dissolved in the second organic solvent 61. In one embodiment, the second organic solvent 62 is selected from a group consisting of toluene, benzene, hexane, and chloroform. In FIG. 5C, let the second organic solvent 62 vaporize and the germanium nanowires 61 remain in the Teflon mold 40. Next, bake the Teflon mold 40 in a vacuum oven to eliminate the residual second organic solvent 62. Next, open the Teflon mold 40 and scrape off the copper nanowire fabric 111 and the germanium nanowire fabric 112 stacked over the copper nanowire fabric 111. Next, place the copper nanowire fabric 111 and the germanium nanowire fabric 112 in a quartz tube, and fill the quartz tube with argon and hydrogen. Then, sinter the copper nanowire fabric 111 and the germanium nanowire fabric 112 at a temperature of about 500° C. to reduce the oxides of copper and germanium and remove the oily materials on the surfaces of the copper nanowire fabric 111 and the germanium nanowire fabric 112, wherein the oily material on the surface of the copper nanowire fabric 111 is Oleylamine (OLA), and the oily material on the surface of the germanium nanowire fabric 112 is 1-dodecanethiol. Thus is obtained a germanium/copper nanowire fabric, which can be used to fabricate the lithium ion battery of the present invention, as shown in FIG. 5D.

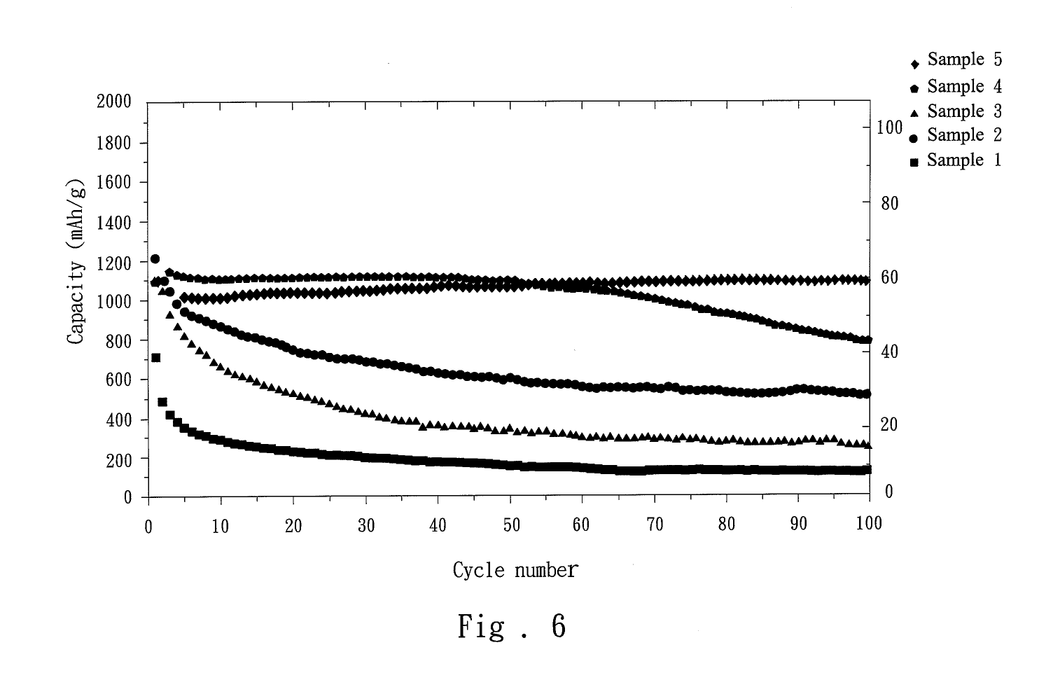

Experiments are used to verify the efficacies of the present invention. However, it should be understood that these experiments are only to verify the present invention but not to limit the scope of the present invention. Refer to FIG. 6 and Table.1. FIG. 6 shows the relationships between the cycles and capacities of the lithium ion batteries using nanowire fabrics fabricated in different processes and having different structures. The points in FIG. 6 denote the relationships between the numbers of the charge-discharge cycles and the capacities of the batteries of from Sample 1 to Sample 6. Table.1 summarizes the results of the experiments, wherein Samples 1-3 are the conventional lithium ion batteries used as the control group; Sample 4 and Sample 5 are the lithium ion batteries of the present invention and used as the experimental group. Samples 1-5 are the CR2032 button cells whose structures and materials are identical except the first current collectors and the active materials of the anodes are different.

Sample 1 uses an unsintered germanium nanowire fabric as the anode. As the electric conductivity of the unsintered germanium nanowire fabric is very poor, the capacity of Sample 1 greatly decreases after only few charge-discharge cycles. The capacity of Sample 1 decreases to less than 130 mAh/g after 100 charge-discharge cycles. Sample 2 uses a sintered germanium nanowire fabric as the anode and has more stable charge-discharge cycles than Sample 1 using the unsintered germanium nanowire fabric. However, the capacity of Sample 2 decreases to only 507 mAh/g after 100 charge-discharge cycles. In sample 3, a germanium nanowire fabric is placed on a copper foil to form the anode of a lithium ion battery. An unexpected result is found in the experiment: adding the copper foil to the anode does not increase the capacity but decreases the capacity to a further lower level. Sample 3 has a capacity of only 264 mAh/g after 100 charge-discharge cycles. The result may be attributed to two phenomena: the poor attachability of the germanium nanowire fabric to the copper foil causes a high contact resistance therebetween; the expansion and contraction of the germanium nanowires during charge-discharge cycles causes the germanium nanowire fabric to peel off from the copper foil and thus degrades the performance.

In the fabrication of Sample 4, the copper nanowire fabric 111 is added to the germanium nanowire fabric 112 to form a germanium/copper nanowire fabric functioning as the anode. The germanium nanowire fabric 112 is attached to the copper nanowire fabric 111 very well and hard to peel off from the copper nanowire fabric 111. Therefore, the poor attachability in Sample 3 is solved in Sample 4. Sample 4 adopts EC/DMC as the electrolyte. It is found in the experiment: the stability of the charge-discharge cycles of Sample 4 is much higher than the abovementioned samples using the nanowire fabrics fabricated in different processes. After 5 charge-discharge cycles, Sample 4 still has a capacity of 1120 mAh/g. However, the capacity of Sample 4 begins to decrease from the 50^{th} cycle. After the 100^{th} cycle ends, only 776 mAh/g of the capacity remains.

Sample 5 adopts the germanium/copper nanowire fabric as the anode and FEC/DEC as the electrolyte. It is found: Sample 5 has superior performance in capacity retention throughout the charge-discharge cycles. After 100 charge-discharge cycles, Sample 5 still has a capacity of as high as 1092 mAh/g.

Refer to Table.2 showing the capacities of the lithium ion batteries using different anodes and charged/discharged at a rate of 1C, wherein Samples A-C use the conventional anodic materials and function as the control group; Sample D adopts the anodic material of the present invention and functions as the experimental group. It is supposed in Table.2: the anode has a size of 1cm² and carries 1 gram of germanium. It is learned from Table.2: at the charge-discharge rate of as high as 1C, Samples A-D, which use germanium nano materials, all have pretty stable high capacities ranging from 850 to 1152 mAh/g. While the conductive agents, adhesive agents and current collectors are taken in consideration, Samples A-C, whose anodes are fabricated in a slurry type process, have capacities of only 93-113 mAh/g. In such a case, Sample D, which uses the germanium/copper nanowire fabric as the anode, still have a capacity of 332 mAh/g, which is about three times the capacity of another sample. Therefore, the lithium ion battery using the germanium/copper nanowire fabric as the anode not only has a lighter weight but also has a higher energy density. The larger the area of the anode, the higher the effect of the present invention.

TABLE 1
Summary of the experimental results of the
charge-discharge cycles of the lithium ion batteries using nanowire
fabrics fabricated in different processes and having different
structures.

| | | | | Capacity (mAh/g) | | | |
|---|---|---|---|---|---|---|---|
| | | | | 1 cycle | 1 cycle | 5 cycles | 100 |
| | Anodic | | | of | of | of | cycles of |
| Sample | material | Electrolyte | Sintering | charge | discharge | discharge | discharge |
| 1 | Ge | EC/DMC | No | 1509 | 717 | 354 | 123 |
| | nanowire | | | | | | |
| | fabric | | | | | | |
| 2 | Ge | EC/DMC | Yes | 1398 | 1213 | 943 | 507 |
| | nanowire | | | | | | |
| | fabric | | | | | | |
| 3 | Ge | EC/DMC | Yes | 1428 | 1166 | 820 | 246 |
| | nanowire | | | | | | |
| | fabric & | | | | | | |
| | Cu foil | | | | | | |
| 4 | Ge/Cu | EC/DMC | Yes | 1342 | 1147 | 1120 | 776 |
| | nanowire | | | | | | |
| | fabric | | | | | | |
| 5 | Ge/Cu | FEC/DEC | Yes | 1350 | 1100 | 1009 | 1092 |
| | nanowire | | | | | | |
| | fabric | | | | | | |

TABLE 2
The capacities of the lithium ion batteries using different
anodes and charged/discharged at a rate of 1 C

| | | | Capacity based |
|---|---|---|---|
| | | | on active material + |
| | | Capacity based | conductive agent + |
| | | on active | adhesive agent + |
| | | material | current collector |
| Sample | Anodic material | (mAh/g) | (mAh/g) |
| ^{a}A | Ge nanowires | 940 | 104 |
| ^{b}B | Ge nanowires | 850 | 93 |
| ^{c}C | Ge nanoparticles | 1152 | 113 |
| ^{d}D | Ge/Cu nanowire | 996 | 332 |
| | fabric | | |

^{a}the discharge capacity after 50 cycles. Refer to “Yuan, F.-W.; Yang, H.-J.; Tuan, H.-Y., Alkanethiol-Passivated Ge Nanowires as High-Performance Anode Materials for Lithium-Ion Batteries: The Role of Chemical Surface Functionalization. ACS Nano 2012, 6 (11), 9932-9942”.
^{b}the discharge capacity after 100 cycles. Refer to “Chockla, A. M.; Klavetter, K. C.; Mullins, C. B.; Korgel, B. A., Solution-grown germanium nanowire anodes for lithium-ion batteries. ACS applied materials & interfaces 2012, 4 (9), 4658-64”.
^{c}the discharge capacity after 200 cycles. Refer to “Klavetter, K. C.; Wood, S. M.; Lin, Y.-M.; Snider, J. L.; Davy, N. C.; Chockla, A. M.; Romanovicz, D. K.; Korgel, B. A.; Lee, J.-W.; Heller, A.; Mullins, C. B., A high-rate germanium-particle slurry cast Li-ion anode with high Coulombic efficiency and long cycle life, Journal of Power Sources 2013, 238, 123-136”.
^{d}the discharge capacity after 100 cycles.

In conclusion, the present invention uses the copper nanowire fabric to fabricate the first current collector of the anode, whereby the anode has a superior energy density. The copper foil of a square centimeter of the conventional current collector weighs 7.7 mg. The same area of the copper nanowire fabric of the present invention weighs only 2-2.5 mg. Suppose the other materials and parameters remain unchanged, the lithium ion battery of the present invention will be lightweighted by 75%. Therefore, the present invention outperforms the conventional lithium ion batteries in lightweightness. Besides, the lithium ion battery using the germanium/copper nanowire fabric as the anode not only needn't use the conductive agent (Super p) and the adhesive agent (PVDF) but also has superior performance in electric capacity during charge-discharge cycles.

What is claimed is:

1. A lithium ion battery using a copper nanowire fabric-based current collector, comprising
an anode including a first current collector and an active material attached to the first current collector;
a cathode including a second current collector and a lithium compound attached to the second current collector to release or to absorb lithium ions; and
a separation unit arranged between the anode and the cathode and including an electrolyte allowing lithium ions to move between the anode and the cathode,
wherein the first current collector includes a copper nanowire fabric.

2. The lithium ion battery using a copper nanowire fabric-based current collector according to claim 1, wherein the active material is a germanium nanowire fabric.

3. The lithium ion battery using a copper nanowire fabric-based current collector according to claim 1, wherein the active material is selected from a group consisting of graphite, silicon, copper phosphide, and germanium.

4. The lithium ion battery using a copper nanowire fabric-based current collector according to claim 1, wherein the active material is in form of particles, powder, nanowires, or a combination thereof.

5. The lithium ion battery using a copper nanowire fabric-based current collector according to claim 1, wherein the second current collector is made of aluminum.

6. The lithium ion battery using a copper nanowire fabric-based current collector according to claim 1, wherein the lithium compound is selected from a group consisting of lithium cobalt oxide, lithium manganese oxide, lithium iron phosphate, and lithium nickel cobalt manganese oxide.

7. The lithium ion battery using a copper nanowire fabric-based current collector according to claim 1, wherein the electrolyte includes a solute Lithium hexafluorophosphate (LiPF₆) and includes a solvent selected from a group consisting of Diethyl carbonate (DEC), Fluoroethylene carbonate (FEC), Ethylene carbonate (EC) and Dimethyl carbonate (DMC).

8. The lithium ion battery using a copper nanowire fabric-based current collector according to claim 1, wherein the copper nanowire fabric includes a plurality of copper nanowires interwoven mutually.
